(19) United States
(12) Patent Application Publication
(10) Pub. No.: US 2022/0306893 A1
(43) Pub. Date: Sep. 29, 2022

(54) VEHICLE TRIM ELEMENT AND CORRESPONDING FABRICATION METHOD

(71) Applicant: FAURECIA INTERIEUR INDUSTRIE, Nanterre (FR)

(72) Inventor: Benjamin QUESNEL, Valencia (ES)

(21) Appl. No.: 17/702,771

(22) Filed: Mar. 23, 2022

(30) Foreign Application Priority Data
Mar. 24, 2021 (FR) FR 21 02947

(51) Int. Cl. C09D 175/04; C09D 167/00

(52) U.S. Cl. CPC C09D 175/04; C09D 167/00

(57) ABSTRACT

A vehicle trim element having at least one coating layer that includes a main layer of a composition having at least natural fibers, a thermoplastic polymer, and a binding agent. The fibers and thermoplastic polymer are ground to form an assembly of particles each having a size substantially between 0.1 and 3.2 mm. The particle assembly is mixed and compressed with the binding agent.

### TECHNICAL FIELD

The present invention relates to a vehicle trim element, in particular for a motor vehicle, comprising a main layer of a composition comprising at least:
fibers;
a thermoplastic polymer; and
a binding agent, said agent binding the fibers and the thermoplastic polymer.

The invention is applicable to a trim element forming a door panel, center console, or instrument panel trim of a vehicle, for example, or other types of trim elements.

### BACKGROUND

Typically, such a trim element comprises a rigid support covered with a coating layer that gives it a desired exterior appearance.

In order to protect the environment, it is known to manufacture the trim elements with a high content of natural recyclable and/or recycled materials.

For example, it is known to manufacture the rigid supports from composite material comprising natural fibers. A fabrication method for this rigid support, called natural fiber polypropylene (NFPP) manufacturing, consists in compressing a mat made of natural fibers entangled with polypropylene fibers. During compression, the mat will melt, forming a matrix. The natural fibers used in this method are between 15 and 30 mm long.

This is different from a fabrication method for this rigid support by injecting a polypropylene matrix in molten form comprising natural fibers into an injection mold.

It is also known to fabricate a coating layer of the rigid support in the form of a thin layer of wood forming a rigid visible surface.

However, for example, in the case of an armrest trim element, such a rigid surface could reduce passenger comfort.

In addition, the fabrication of the rigid NFPP support generates a large amount of unused natural fiber and polypropylene waste.

### SUMMARY

An aim of the invention is to provide an economical and environmentally friendly trim element comprising a soft coating layer with a satisfactory exterior appearance.

To this end, it is an object of the invention to provide a trim element of the aforementioned type, wherein the fibers are natural fibers, the fibers and the thermoplastic polymer being ground to form an assembly of particles each having a size substantially of between 0.1 and 3.2 mm, the particle assembly being mixed and compressed with the binding agent, the assembly comprising the fibers and the thermoplastic polymer represents 10 to 70% of the mass of the main layer, the binding agent represents 2 to 90%, and preferably 20 to 40%, of the mass of the main layer.

The use of natural fibers in the coating layer, from the manufacturing residues of a rigid

NFPP support, for example, offers both an economic and an ecological advantage.

Indeed, such a composition of the main layer with less than 90% of binding agent and 10 to 70% of fibers and thermoplastic polymer makes it possible to ensure the essential mechanical properties of the main layer while optimizing the proportion of natural fibers and thermoplastic polymer, which are preferably bio-sourced and/or recycled, and thus reduce the environmental impact of the fabrication of the main layer.

In addition, grinding the natural fibers and the thermoplastic polymer into small sized particles creates a flexible coating layer.

In addition, the compression of the coating layer results in a thin coating layer.

The trim element according to at least some embodiments of the invention may comprise one or more of the following features, taken alone or in any technically possible combination:
The main layer of the coating layer has a thickness substantially between 0.4 and 1.5 mm.
The fibers are recycled natural fibers.
The binding agent is selected from a polyurethane resin, an acrylic resin and a polyolefin resin.
The thermoplastic polymer is selected from a bio-based polymer, preferably polylactic acid, or a synthetic polymer, preferably polypropylene.
The coating layer comprises at least one support layer having a higher mechanical strength than the main layer.
The coating layer comprises a soft layer comprising recycled polyurethane foam blended with a polyethylene terephthalate resin.
It comprises a rigid support, the coating layer covering at least a portion of the rigid support.
The composition of the main layer comprise pigments and/or additives;
The coating layer comprises a protective film extending over at least a portion of the main layer, the protective film being polyurethane.

The invention also relates to a fabrication method for a trim element comprising the following steps:
providing natural fibers and a thermoplastic polymer;
grinding the natural fibers and the thermoplastic polymer, so as to obtain an assembly of particles each having a size substantially between 0.1 and 3.2 mm;
providing a binding agent in the form of a resin;
mixing the particle assembly with the bonding agent; and
compressing the particle assembly with the binding agent to form a main layer of a coating layer of the trim element.

The fabrication method may comprise an additional step of fabricating a soft layer comprising the following sub-steps:
grinding recycled polyurethane foam residues so as to obtain particles sized less than 12 mm, and preferably less than 5 mm; and
mixing the particles with polyethylene terephthalate resin.

### BRIEF DESCRIPTION OF THE DRAWINGS

The invention will be better understood from the following description, given only by way of example, and made with reference to the appended drawings, in which:

FIG. 1 is a schematic view of a trim element according to an embodiment of the invention,

FIG. 2 is a schematic view of a facility implementing a first method for fabricating a main layer of the trim element of FIG. 1,

FIG. 3 is a schematic view of a facility implementing a method for fabricating a soft layer of the trim element of FIG. 1,

FIG. 4 is a schematic view of a facility implementing a second method for fabricating the main layer of the trim element of FIG. 1, and

FIG. 5 is a schematic view of a facility implementing a third method for fabricating the main layer of the trim element of FIG. 1.

### DETAILED DESCRIPTION

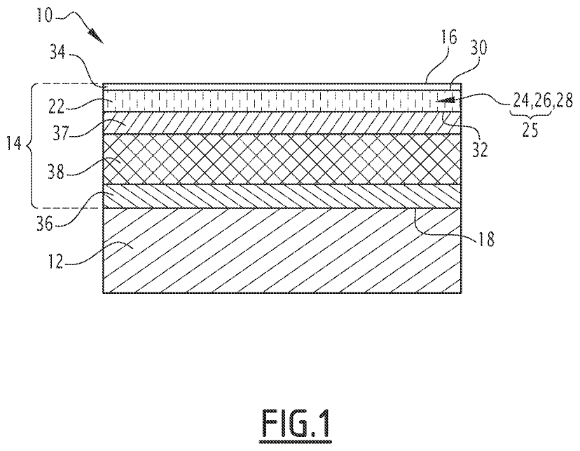

FIG. 1 illustrates a vehicle trim element 10, in particular a motor vehicle. This representation is schematic and the proportions are not observed.

The trim element 10 is a door panel, a center console or a dashboard trim of a vehicle, for example, or the like.

The trim element 10 comprises at least one coating layer 14. According to one embodiment that will now be described, the trim element 10 further comprises a rigid support 12.

The rigid support 12 provides the shape of the trim element 10 and also provides some of its mechanical properties, in particular its rigidity. Thus, the rigid support 12 has a three-dimensional shape, for example.

The rigid support 12 is made of a substantially rigid material, such as a plastic or a composite material. Accordingly, the rigid support 12 has a stable shape that is substantially non-deformable under normal conditions of use, i.e. when normal stresses during use of a vehicle are applied to the support.

For example, the rigid support 12 is made of a thermoplastic material such as an olefinic plastic material or acrylonitrile butadiene styrene thermoplastic polymer.

In a variant, the rigid support 12 is made of a composite material and more particularly a composite material comprising natural fibers. The natural fibers are, for example, selected from flax, hemp, kenaf, coir, sisal, henequen, jute and/or wood.

The rigid support 12 is for example manufactured according to a natural fiber polypropylene (NFPP) manufacturing method, i.e. by compressing a mat comprising natural fibers entangled with polypropylene fibers.

The natural fibers are then chosen with a length between 15 and 30 mm.

In a variant, the rigid support 12 is made by injecting into an injection mold a polypropylene matrix in molten form comprising natural fibers.

The coating layer 14 covers at least a portion of the rigid support 12, advantageously the entire rigid support 12.

The coating layer 14 is made of a flexible material preferably having a greater flexibility than the rigid support 12.

The coating layer 14 is capable of being elastically deformed under normal conditions of use, when a user leans on it for example.

Advantageously, the coating layer 14 conforms to the shape of the rigid support 12.

The coating layer 14 comprises an upper surface 16 forming the outer surface of the trim element 10 visible from the vehicle passenger compartment and a lower surface 18 fixed to the rigid support 12, by gluing for example.

The coating layer 14 is used to impart its appearance to the trim element 10.

The coating layer 14 comprises a main layer 22.

The main layer 22 advantageously has a thickness, measured in the direction separating the outer surface from the inner surface, of between 0.4 mm and 1.5 mm.

The composition of the main layer 22 comprises fibers 24, a thermoplastic polymer 26, and a binding agent 28.

The fibers 24 are natural fibers, preferably recycled natural fibers.

In a variant, the natural fibers 24 are virgin natural fibers, i.e. fibers not previously used in the manufacture of another product.

In a preferred embodiment, the natural fibers 24 are derived, from natural fiber residues from NFPP scraps 40 generated during the manufacture of the rigid support 12 using an NFPP manufacturing method, for example.

The natural fibers 24 are selected from flax, hemp, kenaf, coir, sisal, henequen, jute and/or wood, for example.

The thermoplastic polymer 26 is selected from a bio-based polymer, preferably polylactic acid, or a synthetic polymer, preferably polypropylene.

In the preferred embodiment in which NFPP scraps 40 are recycled, the thermoplastic polymer 26, in this case polypropylene, is in a molten state mixed with the natural fibers 24.

In a variant, the thermoplastic polymer 26 is in the form of virgin fibers. The natural fibers 24 and the thermoplastic polymer 26 are blended.

The fibers 24 and the thermoplastic polymer 26 are ground to form an assembly 25 of particles, each having a size substantially between 0.1 mm and 3.2 mm, preferably between 0.5 mm and 3 mm.

The particle size refers to the largest dimension of the particle. For example, in the case of an elongated particle, such as a fiber, size refers to the length of the particle.

According to a particular embodiment, the particle assembly 25 comprises only the natural fibers 24 and the thermoplastic polymer 26.

The particle assembly 25 comprising the fibers 24 and the thermoplastic polymer 26 represents 10 to 70% of the mass of the main layer 22, in particular 40 to 70% of the mass of the main layer 22.

The particle assembly 25 comprises between 40 and 90% of fibers 24 and between 10 and 60% of thermoplastic polymer 26, for example. The particle assembly 25 comprises substantially 50% of fibers 24 and 50% of thermoplastic polymer 26, in particular, which corresponds to the proportions usually chosen during the manufacture of a rigid NFPP support. The role of the binding agent 28 is to bind the natural fibers 24 with the thermoplastic polymer 26.

The binding agent 28 is latex, for example.

In one embodiment, the binding agent 28 is a polyurethane resin, more particularly of natural origin, such as based on a natural polyol oil. A polyurethane resin has the advantage of good aging properties.

In another embodiment, the binding agent 28 is an acrylic or polyolefin resin.

The binding agent 28 represents 2 to 90%, preferably 2 to 50%, and most preferably 20 to 40%, of the mass of the main layer 22.

The proportion of binding agent 28 is chosen to ensure the mechanical characteristics of the main layer 22, while remaining as low as possible, to optimize the proportion of the assembly 25 comprising the natural fibers 24 and the thermoplastic polymer 26.

A main layer 22 in which the assembly 25 represents more than 70% of the mass of said main layer 22 would not have the desired mechanical properties, particularly in terms of mechanical strength.

The mixture comprising particle assembly 25 and binding agent 28 was then compressed to form the main layer 22.

For example, said mixture has been rolled to form a main layer 22 with a thickness of between 0.4 and 1.5 mm.

Before compression, the base weight of the assembly 25 comprising natural fibers 24 and thermoplastic polymer 26 mixed with binding agent 28 is between 50 and 400 g/m², for example.

The composition of the main layer 22 advantageously also comprises pigments and/or additives 29.

The pigments make it possible to color the main layer 22 with a desired color and to improve the appearance thereof

The pigments are in the form of a powder which is mixed with the binding agent 28, for example.

The pigments are preferably of natural origin, more particularly extracted from dye plants.

The pigments show less than 10% of the mass of the main layer 22.

The additives 29 are synthetic additives sprayed onto the main layer 22 before compression, for example.

Advantageously, the additives 29 are used to increase the UV, chemical and abrasion resistance.

The additives 29 show less than 10% of the mass of the main layer 22.

The main layer 22 may also contain one or more of the following components: greases, grease retention components, and a rubber binding agent.

Advantageously, said components are of natural origin.

The main layer 22 defines an top surface 30 defining a visible surface of the coating layer 14 and a lower surface 32.

Compression of the main layer 22 results in a smooth appearance of the top surface 30.

Optionally, the top surface 30 is sanded, to give it a rough appearance.

Advantageously, the coating layer 14 comprises a protective film 34 attached to the top surface 30 of the main layer 22.

The protective film 34 forms the upper surface 16 of the coating layer 14 and thus defines a visible surface of the coating layer 14.

The protective film 34 is made of polyurethane, and preferably of naturally occurring polyurethane.

In a variant, the protective film 34 is thermoplastic polyurethane, preferably of natural origin.

The protective film 34 may also contain pigments and/or additives, for example intended to protect against UV or abrasion.

The protective film 34 may be transparent, translucent or opaque, depending on the desired external appearance.

For example, an opaque protective film 34 provides a smooth monochromatic aesthetic appearance, for example due to the presence of pigments in the composition of the protective film 34. The particles of the particle assembly 25 are not visible.

A translucent or transparent protective film 34 allows the appearance of the main layer 22 to remain visible. An external appearance is obtained with the particles of the particle assembly 25 visible. The visible appearance of the particles can also be amplified or attenuated by selecting a more or less translucent or opaque binding agent 28.

The protective film 34 may be attached to the top surface 30 of the main layer 22 by bonding, casting or spraying the protective film 34 directly onto the top surface 30 of the main layer 22.

The protective film 34 may be a single layer or a stack of layers each having a different functionality.

For example, the protective film 34 may consist of a top layer containing additives for

UV protection, a middle layer containing pigments, and a bottom layer containing additives to facilitate bonding with the main layer 22.

Advantageously, the coating layer 14 also comprises a soft layer 38 providing the benefit of making the coating layer 14 more soft to the touch for passengers.

The soft layer 38 is a polyurethane foam layer or a fabric, for example.

The soft layer 38 preferably comprises recycled polyurethane foam 39 blended with a polyethylene terephthalate (PET) resin 41.

According to one particular embodiment of the invention, the soft layer 38 comprises only recycled polyurethane foam mixed with polyethylene terephthalate (PET) resin 41.

Recycled foam residues 39 have preferably been ground to have particle 45 sizes of less than 12 mm, and preferably less than 5 mm. Preferably, at least 60% of the volume of the ground foam particles 45 are between 1 and 3 mm in size.

The ground foam particles 45 comprise a mixture of 20 to 95% ground recycled polyurethane and 5 to 80% ground polyethylene terephthalate.

Advantageously, the soft layer 38 has a thickness of between 0.5 mm and 6 mm.

The soft layer 38 preferably has a density of between 30 to 70 kg/m³ and for example equal to 50 kg/m³.

The soft layer 38 preferably has a tensile strength greater than 200 kPa and a compressive stress, defined according to ISO 3386-1 (version of Oct. 1, 2015) of between 15 kPa and 40 kPa. The coating layer 14 also comprises at least one support layer 36, 37 having a higher mechanical strength than the main layer 22.

As illustrated in FIG. 1, the coating layer 14 comprises two support layers 36, 37, for example. A first support layer 36 is attached to the rigid support 12 below the soft layer 38 and a second support layer 37 is attached between the soft layer 38 and the main layer 22.

In a variant, the coating layer 14 comprises only the first support layer 36 attached to the rigid support 12 below the soft layer 38 or only a second support layer 37 attached between the soft layer 38 and the main layer 22

Each support layer 36, 37 has a higher mechanical strength than the main layer 22.

When faced with external stress, the support layer(s) 36, 37 are able to withstand longer and higher stress without deforming or breaking than the main layer 22.

Each support layer 36, 37 preferably has a tensile strength of between 50 and 130 N.

The role of the support layer(s) 36, 37 is to stiffen the coating layer 14 to improve the mechanical performance of the coating layer 14.

The first support layer 36 attached to the rigid support 12 also facilitates plating of the coating layer 14 against the rigid support 12.

Each support layer 36, 37 is for example made of a composite material comprising non-woven fibers in a polymer, more particularly in a polyether sulfone or polyamide.

The fibers are preferably of natural origin and advantageously are recycled fibers. The natural fibers included in the support layer 36 have an average length of between 20 mm and 90 mm, and preferably substantially equal to 60 mm.

The first support layer 36 is glued to the rigid support 12 and to the soft layer 38, for example. The second support layer 37 is bonded on one side to the soft layer 38 and on the other side to the lower surface 32 of the main layer 22, for example.

A method for fabrication such a trim element 10 will now be described.

First, the rigid support 12 is made of a composite material comprising natural fibers and preferably made according to a natural fiber polypropylene (“NFPP”) manufacturing method, i.e. by compressing a mat comprising natural fibers entangled with polypropylene fibers.

The fabrication of the rigid support 12 using this method results in NFPP scrap parts 40. Scrap NFPP parts from the remnants of other vehicle parts manufactured at the same or another production facility may also be provided.

The NFPP part scraps 40 then include natural fibers 24 and thermoplastic polymer 26 in a molten state.

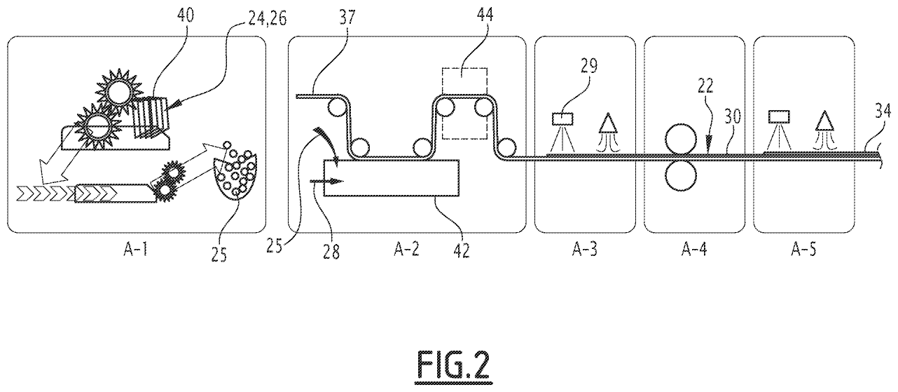

FIG. 2 illustrates a first method for manufacturing the main layer 22 in the case where the binding agent 28 is a polyurethane resin. The natural fibers 24 and the thermoplastic polymer 26 are provided, and advantageously in the form of NFPP scrap parts 40.

The NFPP scrap parts 40 are ground to provide an assembly 25 of particles each having a size substantially between 0.1 mm and 3.2 mm, preferably between 0.5 mm and 3 mm.

As illustrated in step A-1 of FIG. 2, the scrap parts 40 advantageously undergo two successive grinding steps, for example a first coarse grinding and a second finer grinding.

A system comprising sieves makes it possible to recover the particles of the desired size after grinding. For example, a first sieve is calibrated to allow particles smaller than 3.2 mm to pass and a second sieve installed under the first sieve is calibrated to allow particles smaller than 0.1 mm to pass. The particles passed through the first sieve but stopped by the second sieve thus have a size of between 0.1 and 3.2 mm and are recovered for the manufacture of the packing element.

As illustrated in step A-2 of FIG. 2, the assembly 25 comprising fibers 24 and thermoplastic polymer 26 is then mixed with the binding agent 28, in this case polyurethane resin in a tank 42.

Optionally, pigments and additives are also added to the tank 42.

Optionally, a solvent is also added to the tank 42 to mix the various elements present therein. The solvent is, for example, water-based or organic.

A support, advantageously the second support layer 37, is provided. Said support is then impregnated with the mixture of the assembly 25 and the binding agent 28 by being soaked in the tank 42, and is finally dried in an oven 44.

According to this particular fabrication method, the main layer 22 and the support layer 37 are merged together and do not form two layers distinct from each other. The support layer 37 is impregnated with the main layer 22.

As illustrated in step A-3 of FIG. 2, the binding agent 28 in the form of resin and optionally additives 29, preferably also in the form of resin, can then be atomized, for example to form a UV protective layer. The layer thus formed is then dried.

As illustrated in step A-4 of FIG. 2, the layer thus formed is compressed to form the main layer 22 with a thickness of between 0.4 and 1.5 mm.

The compression step is carried out, for example, by rolling, by continuous compression or by means of a static press.

During this compression step, patterns can be made on the main layer 22 by an engraving or embossing method.

The compression of the main layer 22 results in a smooth top surface 30.

Optionally, the top surface 30 is sanded, to give it a rough appearance.

Optionally, as shown in step A-5 of FIG. 2, a protective film 34 is then sprayed directly onto the top surface 30 of the main layer 22.

In a variant, not shown, the protective film 34 is bonded or injected directly onto the top surface 30 of the main layer 22.

A support layer 36 of higher mechanical strength than the main layer 22 is then optionally provided.

Advantageously, each step of the method for manufacturing the main layer 22 is performed at a temperature below the melting temperature of the thermoplastic polymer 26, in order to obtain a flexible and non-brittle main layer 22.

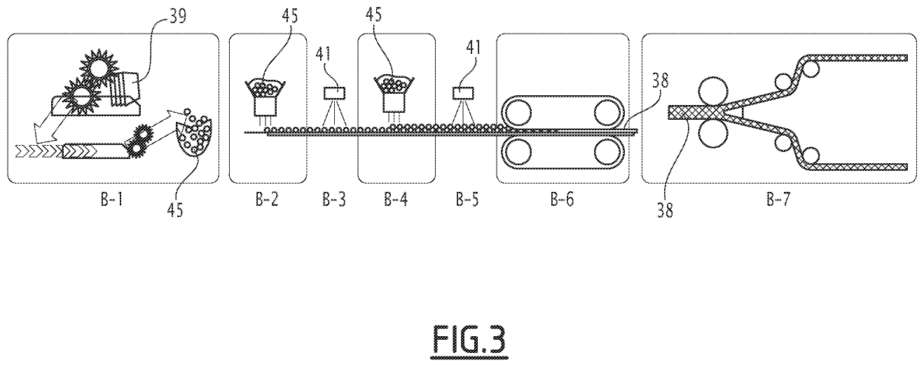

FIG. 3 illustrates a method for making the soft layer 38.

The polyurethane foam, and preferably residues 39 of recycled polyurethane foam, are ground to obtain particles 45 with an average size of less than 12 mm, and preferably less than 5 mm. Preferably, at least 60% of the volume of the ground foam particles 45 have an average size between 1 and 3 mm.

The ground foam particles 45 comprise a mixture of 20 to 95% ground recycled polyurethane and 5 to 80% ground polyethylene terephthalate.

The ground foam particles 45 and resin 41, preferably polyethylene terephthalate (PET), are then mixed.

For example, as illustrated in step B-2 of FIG. 3, the ground foam particles 45 are then scattered onto a support, advantageously the support layer 36 that was provided upstream.

Following this scattering step B-2, the resin, preferably polyethylene terephthalate (PET), is mixed with the ground foam particles 45 by spraying, as illustrated in step B-3 of FIG. 3.

Advantageously, these two steps are repeated a second time and thus form the soft layer 38.

The soft layer 38 is then heat laminated to bond the two layers together and reduce the thickness of the two layers.

As illustrated in step B-7 of FIG. 3, the soft layer 38 is then cut along a direction perpendicular to a thickness direction of the soft layer 38, to obtain two soft layers 38 with a thickness between 0.5 and 6 mm.

One of the soft layers 38 thus obtained is then heat-laminated with a support layer 36 in order to bond the two layers together and reduce the thickness of these two layers.

The soft layer 38 bonded to the support layer 36 is then bonded to the support layer 37 or directly to the lower surface 32 of the main layer 22, forming the coating layer 14.

The resulting coating layer 14 is then attached to the rigid support 12, for example by bonding.

In a variant, the rigid support 12 is over-molded onto the coating layer 14.

The coating layer 14 thus created has the advantage of being flexible and having a high content of components of natural origin and advantageously recycled.

The trim element 10 produced in this way is economical and environmentally friendly due to the use in the manufacture of the coating layer 14 of natural fiber residues not used in the manufacture of the rigid support 12 or from manufacturing remnants of other vehicle parts manufactured in the same or another production facility.

In addition, the coating layer 14 provides a satisfactory exterior appearance, with, for example, the possibility of presenting a natural exterior appearance.

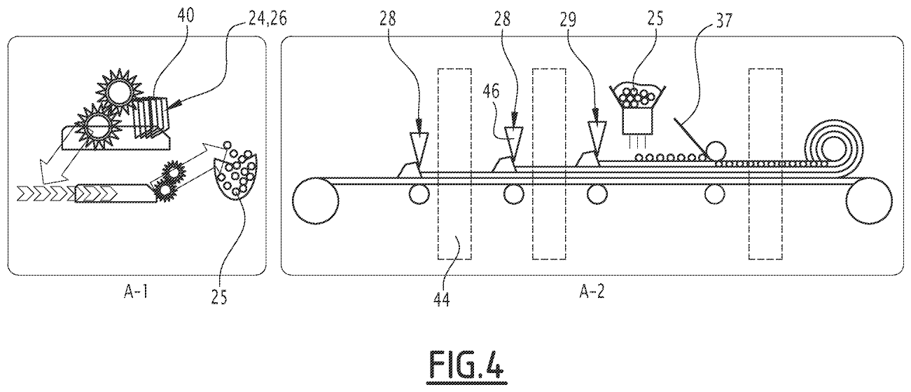

According to another embodiment, the main layer 22 is manufactured according to a manufacturing method illustrated in FIG. 4. As in the previous method, the binding agent 28 is a polyurethane resin.

Unlike the method in FIG. 2, the assembly 25 is mixed with the binding agent 28, by scattering the assembly 25 comprising natural fibers 24 and thermoplastic polymer 26 onto a support formed by the binding agent 28.

The scattering is carried out with the aid of a device consisting of at least one brush in the form of a roller which pivots on itself, for example.

The carrier formed by the binding agent 28 is made by successive deposition of resinous binding agent 28, for example. and optionally resinous additive. As illustrated in FIG. 4, the thickness of resin deposited is controlled by spreading with a knife 46, for example. A resin deposit is always followed by a drying step in an oven 44 before the next resin deposit.

The layer thus formed is then compressed, and preferably heat-laminated with the second support layer 37.

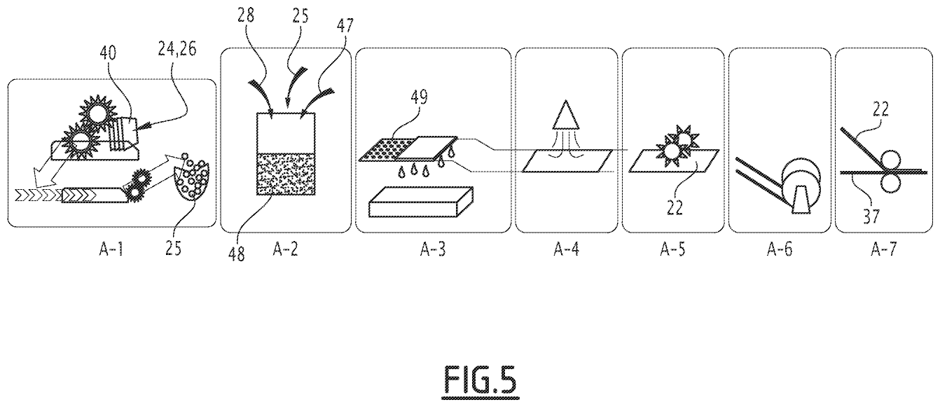

According to another embodiment in the case where the binding agent 28 is an acrylic or polyolefin resin, the main layer 22 is manufactured according to a third manufacturing method illustrated in FIG. 5.

After grinding step A-1, the assembly 25 comprising natural fibers 24 and thermoplastic polymer 26 is mixed with binding agent 28 and water 47 in an automatic agitator 48, as illustrated in step A-2 of FIG. 5.

The resulting mixture is then dewatered by transporting it on a perforated conveyor 49, for example, as shown in step A-3 of FIG. 5.

As shown in steps A-4 and A-5 of FIG. 5, the layer is then dried and softened and polished to adjust the thickness to the desired main layer 22.

The main layer 22 is then wound and compressed by pressure and temperature lamination onto the support layer 37, as illustrated in steps A-6 and A-7 of FIG. 5.

In an alternative embodiment not shown, the method for making the main layer 22 also includes an additional step of orienting the particles of the particle assembly 25.

Advantageously, the particles are oriented in a direction substantially parallel or substantially perpendicular to the thickness of the main layer 22.

For example, the particles are oriented by a method using static energy or high voltage, or by a hydroentanglement method.

This particle orientation allows the top surface 30 to have an exposed fiber, suede-like appearance.

1. A vehicle trim element comprising at least one coating layer comprising a main layer of a composition comprising at least:
fibers;
a thermoplastic polymer; and
a binding agent, said agent binding the fibers and the thermoplastic polymer;
wherein the fibers are natural fibers, the fibers and the thermoplastic polymer being ground to form an assembly of particles each having a size substantially between 0.1 and 3.2 mm; the particle assembly being mixed and compressed with the binding agent, the assembly comprising the fibers and the thermoplastic polymer represents 10 to 70% of the mass of the main layer, the binding agent represents 2 to 90% of the mass of the main layer.

2. The trim element according to claim 1, wherein the main layer of the coating layer has a thickness substantially between 0.4 and 1.5 mm.

3. The trim element according to claim 1, wherein the fibers are recycled natural fibers.

4. The trim element according to claim 1, wherein the binding agent is selected from a polyurethane resin, an acrylic resin and a polyolefin resin.

5. The trim element according to claim 1, wherein the thermoplastic polymer is selected from a bio-based polymer or a synthetic polymer.

6. The trim element according to claim 1, wherein the coating layer comprises at least one support layer having a higher mechanical strength than the main layer.

7. The trim element according to claim 1, wherein the coating layer comprises a soft layer comprising recycled polyurethane foam mixed with polyethylene terephthalate resin.

8. The trim element according to claim 1 comprising a rigid support, the coating layer covering at least a portion of the rigid support.

9. A fabrication method for a trim element comprising the following steps:
providing natural fibers and a thermoplastic polymer;
grinding the natural fibers and the thermoplastic polymer, so as to obtain an assembly of particles each having a size substantially between 0.1 and 3.2 mm;
providing a binding agent in the form of resin;
mixing the particle assembly with the binding agent; and
compressing the particle assembly with the binding agent to form a main layer of a coating layer of the trim element.

10. The fabrication method according to claim 9, comprising an additional step of manufacturing a soft layer comprising the following sub-steps:
grinding recycled polyurethane foam residues, so as to obtain particles of size less than 12 mm; and
mixing the particles with polyethylene terephthalate resin.
